(19) United States
(12) Patent Application Publication
(10) Pub. No.: US 2015/0173418 A1
(43) Pub. Date: Jun. 25, 2015

(54) DEVICE FOR ADAPTING A BOTTLE FOR USE AS A SMOKING APPARATUS

(71) Applicant: James MCARTHUR, Huntsville (CA)

(72) Inventor: James MCARTHUR, Huntsville (CA)

(21) Appl. No.: 14/134,343

(22) Filed: Dec. 19, 2013

(51) Int. Cl. A24F 5/00; A24F 1/00; B26F 1/16; B26B 11/00; B26F 1/32

(52) U.S. Cl. CPC A24F 5/00; B26B 11/00; B26F 1/32; B26F 1/16; A24F 1/00

(57) ABSTRACT

A device for adapting a bottle for use as a smoking apparatus is provided. The device comprises: a handle; a puncturing portion extending from the handle, the puncturing portion configured to both: puncture a top of a threaded bottle cap such that the puncturing portion can be inserted through the top of the threaded bottle cap; and retain a portion of a herbal concentrate thereafter; and, an engaging portion configured to engage the top of the threaded bottle cap once the puncturing portion is inserted there through.

### FIELD

The specification relates generally to smoking devices, and specifically to a device for adapting a bottle for use as a smoking apparatus.

### BACKGROUND

Smoking of herbal concentrates can require use of a special device including a pipe, a shisha, a hookah, a waterpipe and the like. However, such devices may not always be available, and/or may not be portable enough for a user to carry around, and can result in inhalation of fumes from burnt fuels for ignition and/or unfiltered tobacco-like products used to aid in the smoldering of the herbal concentrates.

### SUMMARY

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

An aspect of the specification provides a device comprising: a handle; a puncturing portion extending from the handle, the puncturing portion configured to both: puncture a top of a threaded bottle cap such that the puncturing portion can be inserted through the top of the threaded bottle cap; and retain a portion of a herbal concentrate thereafter; and, an engaging portion configured to engage the top of the threaded bottle cap once the puncturing portion is inserted there through.

The engaging portion can be located at a base of the puncturing portion, adjacent the handle.

A length from a top of the puncturing portion to the handle can be greater than or about equal to a cylindrical length of the threaded bottle cap.

A length from a top of the puncturing portion to the handle can be in a range of about 10 mm to about 50 mm.

An angle of a tip of the puncturing portion can be in a range of about 0.1° to about 15°.

The puncturing portion can comprise one or more of a spike and an awl.

The puncturing portion can comprise a drill tip.

The engaging portion can be cylindrical.

The engaging portion can be insertable through the top of the threaded bottle cap once the puncturing portion is inserted there through.

The engaging portion can comprise ribs for engaging the top of the threaded bottle cap when the engaging portion is inserted there through.

The engaging portion can comprise threads for engaging the top of the threaded bottle cap when the engaging portion is inserted there through.

The device can further comprise a removable cover configured to be retained by the engaging portion and cover the puncturing portion.

The device can further comprise a key chain.

The device can further comprise a second puncturing portion extending from the handle at an end opposite the puncturing portion, the second puncturing portion having one or more of a larger width and a larger diameter than the puncturing portion. The puncturing portion can comprise one or more of a spike and an awl, and the second puncturing portion can comprise a drill tip. The device can further comprise a second engaging portion configured to engage the top of the threaded bottle cap once the second puncturing portion is inserted there through. The device can further comprise a removable cap configured to be retained by the second engaging portion and cover the second puncturing portion.

The handle can comprise an elongated cylinder.

The handle can comprise ribs to assist gripping when one or more of: the puncturing portion is puncturing the threaded bottle cap; and the engaging portion is engaging the top of the threaded bottle cap.

Another aspect of the specification provides a a system comprising: a bottle comprising a threaded neck defining an opening; a threaded bottle cap complementary to the threaded neck, the threaded bottle cap configured to be removabley attached to the threaded neck; and, a device comprising: a handle; a puncturing portion extending from the handle, the puncturing portion configured to both: puncture a top of the threaded bottle cap such that the puncturing portion can be inserted through the top of the threaded bottle cap; and received and retain a portion of a herbal concentrate thereafter; and, an engaging portion configured to engage the top of the threaded bottle cap once the puncturing portion is inserted there through, such that, when the herbal concentrate is one or more of lit and smoldering, once retained by the puncturing portion, the threaded bottle cap can be attached to the bottle and smoke from the herbal concentrate collected therein, for inhalation when the threaded bottle cap is removed from the threaded neck.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts a device for adapting a bottle for use as a smoking apparatus, according to non-limiting implementations.

FIG. 2 depicts the device of FIG. 1 covered and uncovered, according to non-limiting implementations.

FIG. 3 depicts a sequence for attaching the device of FIG. 1 to a threaded bottle cap, according to non-limiting implementations.

FIG. 4 depicts a cross-section of the threaded bottle cap of FIG. 3 with the device of FIG. 1 attached thereto, according to non-limiting implementations.

FIG. 5 depicts the device of FIG. 1 attached to a threaded bottle cap, and receiving and retaining a herbal concentrate, according to non-limiting implementations.

FIG. 6 depicts the herbal concentrate retained by the device of FIG. 1 being blown on by a user after the herbal concentrate is lit, and to extinguish a flame, to assist in smoldering of the herbal concentrate, according to non-limiting implementations.

FIG. 7 depicts the threaded bottle cap, attached to the device of FIG. 1 retaining smoldering herbal concentrate, being screwed onto a bottle, so that smoke from the herbal concentrate is retained therein, according to non-limiting implementations.

FIG. 8 depicts a system including a bottle, a threaded bottle cap, and the device of FIG. 1 attached thereto, the bottle collecting smoke from smoldering herbal concentrate retained by the device, according to non-limiting implementations.

FIG. 9 depicts a user inhaling smoke from the bottle of FIG. 8, according to non-limiting implementations.

FIG. 10 depicts an alternative device for adapting a bottle for use as a smoking apparatus, according to non-limiting implementations.

FIG. 11 depicts the device of FIG. 10 with a first cover removed, according to non-limiting implementations.

FIG. 12 depicts the device of FIG. 10 with a second cover being removed, according to non-limiting implementations.

FIG. 13 depicts the device of FIG. 10 with the second cover removed, according to non-limiting implementations.

FIG. 14 depicts an end of the device of FIG. 10 showing a puncturing portion that includes a drill bit, according to non-limiting implementations.

### DETAILED DESCRIPTION

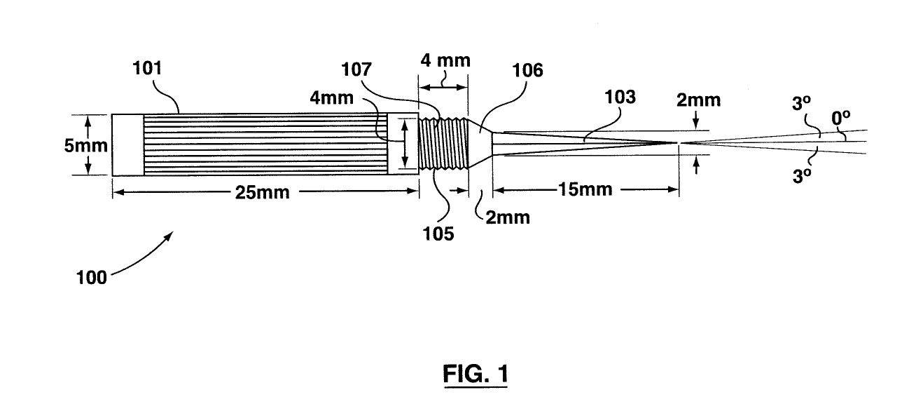

FIG. 1 depicts a device 100 device for adapting a bottle for use as a smoking apparatus, according to non-limiting implementations. Device 100 comprises: a handle 101; a puncturing portion 103 extending from handle 101, puncturing portion 103 configured to both: puncture a top of a threaded bottle cap such that puncturing portion 103 can be inserted through the top of the threaded bottle cap; and receive and retain a portion of a herbal concentrate thereafter; and, an engaging portion 105 configured to engage the top of the threaded bottle cap once puncturing portion 103 is inserted there through. In depicted implementations, engaging portion 105 is located at a base of puncturing portion 103, adjacent handle 101. Operation of device 100 will be described in further detail below.

In depicted implementations, device 100 further comprises an optional transition portion 106 which is conical and/or frustum in shape, between a base of puncturing portion 103 and engaging portion 105: specifically, as depicted and described in further detail below, a base of puncturing portion 103 is wider than a diameter of engaging portion 105; hence a first diameter of transition portion 106 that is adjacent puncturing portion 103 can be similar to a diameter of a base of puncturing portion 103; and a second diameter of transition portion 106, adjacent engaging portion 105, can be similar to a diameter of engaging portion 105. In other words, transition portion widens from puncturing portion 103 to engaging portion 105.

Dimensions of non-limiting implementations of device 100 are also depicted in FIG. 1. Handle 101 can be generally cylindrical, having a diameter of about 5 mm, and a length of about 25 mm. However, handle 101 need not be cylindrical and other shapes and lengths of handle 101 are within the scope of present implementations. For example, handle 101 can be any shape that can aid in using device 100, and specifically puncturing portion 103, to puncture a threaded bottle cap. For example, a spherical shape and the like. Further, handle 101 can be in a range of 10 mm to about 150 mm, however other lengths are within the scope of present implementations, for example lengths that enable device 100 to be suitable for carrying in a pocket, including, but not limited to, a pocket of an item of clothing.

Engaging portion 105 can also be generally cylindrical, having a diameter of about 4 mm and a length of about 4 mm. However, engaging portion 105 need not be cylindrical, and other shapes of engaging portion 105 are within the scope of present implementations. For example, engaging portion 105 can be any shape that can engage the top of the threaded bottle cap once puncturing portion 103 is inserted there through. For example, engaging portion 105 can be conical, and the like. In some implementations, a width and/or diameter and/or lateral dimension of engaging portion 105 can be larger than a width and/or diameter and/or lateral dimension of a base of puncturing portion 103, so that the material of the top of the threaded bottle cap deforms around engaging portion 105 when engaging portion 105 is engaging the top of the threaded bottle cap.

Transition portion 106 can be generally conical, and can have a length of between about 1 mm and about 5 mm. However, transition portion 106 need not be conical and other shapes of transition portion 106 are within the scope of present implementations. For example, transition portion 106 can comprise a series of widening steps between puncturing portion 103 and engaging portion 105.

Puncturing portion 103 can comprise any shape for puncturing a top of a threaded bottle cap and hence can comprise one or more of a spike and an awl. In some implementations, however, puncturing portion 103 can comprise a drill bit. In implementations where puncturing portion 103 comprises one or more of a spike and an awl, as depicted, puncturing portion 103 comprises a base adjacent engaging portion 105 that tapers to a puncturing tip; the base of puncturing portion 103 can be about 2 mm wide and/or about 2 mm in diameter, and a length of puncturing portion 103 can be about 15 mm. An angle of at least the tip of puncturing portion 103 is about +/−3°, for a total angle of about 6°; further, as depicted, puncturing portion 103 widens at about 3° to engaging portion 105.

However, other dimensions of device 100 are within the scope of present implementations. For example, an angle of at least the tip of puncturing portion 103 can be in a range of about 0.1° to about 15°; however any angle that enables puncturing portion 103 to puncture a threaded bottle cap is within the scope of present implementations. Further, any length and diameter of engaging portion 105 that enables engaging portion 103 to engage and/or retain a threaded bottle cap is within the scope of present implementations. As will presently be described, once puncturing portion 103 and engaging portion 105 are inserted through a threaded bottle cap, a herbal concentrate is received by and/or stuck to and/or retained by at least the tip of puncturing portion 103, lit on fire, blown out and/or extinguished, so that the herbal concentrate smolders and produces smoke, and the threaded bottle cap is then removabley attached to a complementary opening of a bottle (e.g. the threaded bottle cap is screwed onto the neck of a bottle), and the bottle then collects the smoke from the herbal concentrate.

Hence, in some limitations, a combined length of puncturing portion 103, transition portion 106 and engaging portion 105 can be greater than or about equal to a cylindrical length of the threaded bottle cap so that there is at least some clearance between a rim of the threaded bottle cap and the tip of puncturing portion 103. In other words a distance between the tip of puncturing portion 103 and handle 101 can be greater than or about equal to a cylindrical length of the threaded bottle cap so that there is at least some clearance between a rim of the threaded bottle cap and the tip of puncturing portion 103. As depicted, the combined length of puncturing portion 103, transition portion 106 and engaging portion 105 is about 21 mm, which is greater than a cylindrical length of a threaded bottle cap of bottles, including, but not limited to, a two litre plastic bottle (e.g. made from polyethylene terephthalate (PET)), however cylindrical lengths of threaded bottle caps of bottles of different sizes can come in various sizes ranging from less than about 10 mm to more than about 32 mm; hence, the combined length of puncturing portion 103, transition portion 106 and engaging portion 105 be in a range of 10 mm to about 40 mm and/or from about 10 mm to about 50 mm, however other lengths are within the scope of present implementations, for example lengths that enable device 100 to be suitable for carrying in a pocket, including, but not limited to, a pocket of an item of clothing. Should manufacturer's of threaded bottle caps develop a threaded bottle cap that is outside these ranges, device 100 can be adapted accordingly.

Furthermore, device 100 can be portable (readily movable from place to place) and, is generally handheld (sized and shaped to be held or carried in a human hand, and typically used while so held or carried). Hence, dimensions of device 100 generally enable device 100 to be portable and/or handheld and/or containable in a pocket and/or containable in a backpack, purse, and the like.

In particular, handle 101 is generally sized and shaped to be used by a human hand to aid in puncturing portion 103 to puncture a top of a threaded bottle cap. For example, as described above, handle 101 can comprise an elongated cylinder. Further, as depicted, handle 101 can comprise ribs to assist gripping when one or more of: puncturing portion 103 is puncturing the threaded bottle cap; and engaging portion 105 is engaging the top of the threaded bottle cap.

In some implementations, engaging portion 105 can comprises ribs for engaging the top of a threaded bottle cap when engaging portion 105 is inserted there through, for example which can be disposed cylindrically around engaging portion 105 and/or longitudinally along engaging portion 105, and which can be further roughened to assist the engagement.

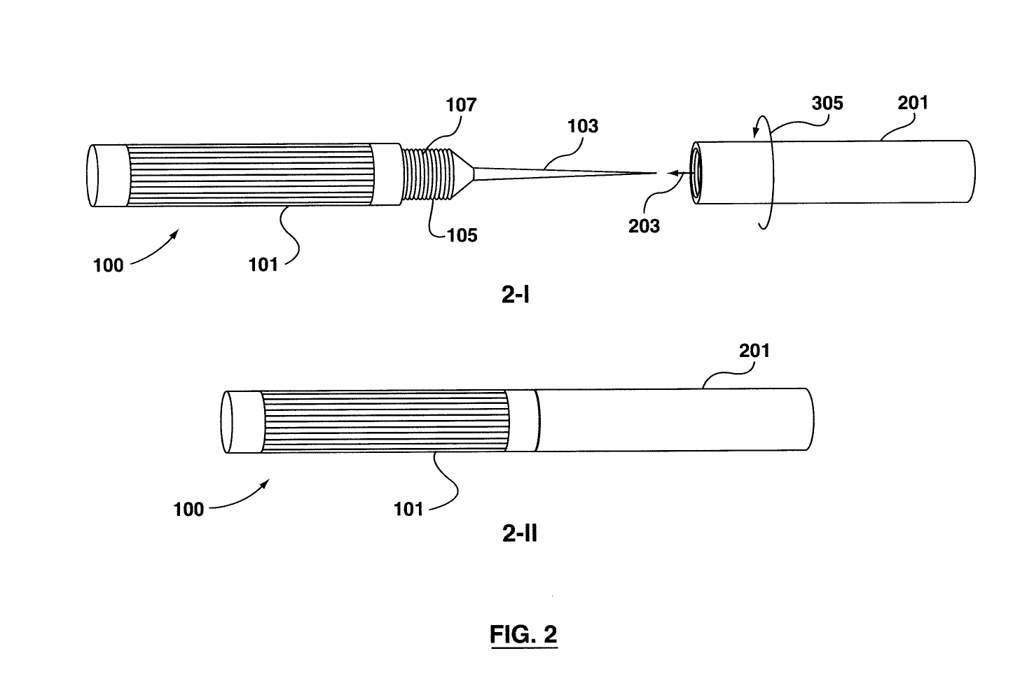

Alternatively, and as depicted, engaging portion 105 comprises threads 107 for engaging the top of a threaded bottle cap when engaging portion 105 is inserted there through. Threads 107 can serve a further function, however. For example, attention is directed to FIG. 2, which depicts two views 2-I, 2-II of device 100. From FIG. 2, it is apparent that, in some implementations, device 100 further comprises an optional removable cover 201 configured to be retained by engaging portion 105 and cover puncturing portion 103. Specifically, as depicted, cover 201 can comprise internal threads (not depicted), which can engage threads 107 of engaging portion 105 to cover puncturing portion 103 when device 100 is not in use.

Hence, in view 2-I, cover 201 is being screwed onto threads 107 of engaging portion 105, as indicated by arrows 203, 305; and in view 2-II, cover 201 is attached to engaging portion 105. Cover 201 can be removed by unscrewing cover 201 from engaging portion 105.

While threads 107 are used to retain a threaded bottle cap to engaging portion, in implementations where engaging portion 105 comprises ribs, the ribs can be used to frictionally retain a threaded bottle cap, similar to threaded bottle cap 301, but lacking internal threads; rather, the ribs frictionally engage the threaded bottle cap, such that the threaded bottle cap can be pulled off engaging portion 105 and/or pushed onto engaging portion 105.

Device 100 can be made of any material and/or combination of materials that can be used to puncture a top of a threaded bottle cap and engage the threaded bottle cap. For example, each of puncturing portion 103 and engaging portion can comprise one or more of a metal, steel, stainless steel, aluminum, ceramic and the like, however, plastics that are harder than a plastic of a threaded bottle cap are also within the scope of present implementations. In particular, the material of each of puncturing portion 103 and engaging portion 105 can depend on a configuration of a type of threaded bottle cap for which device 100 is intended to be used. For example, when device 100 is to be used with plastic threaded bottle caps, puncturing portion 103 can comprise aluminum; however when device 100 is to be used with metal threaded bottle caps, puncturing portion 103 can comprise steel, stainless steel and the like.

Handle 101 can comprise one or more of wood, plastic, metal, steel, stainless steel, ceramic and the like. In some implementations, handle 101, puncturing portion 103 and engaging portion 105 can be integrated and/or made from the same material, while in other implementations, one or more of handle 101, puncturing portion 103 and engaging portion 105 can be made from a different material from the other elements of device 100. Furthermore, one or more of handle 101, puncturing portion 103 and engaging portion 105 can be manufactured separately and assembled with the other elements of device 100 thereafter.

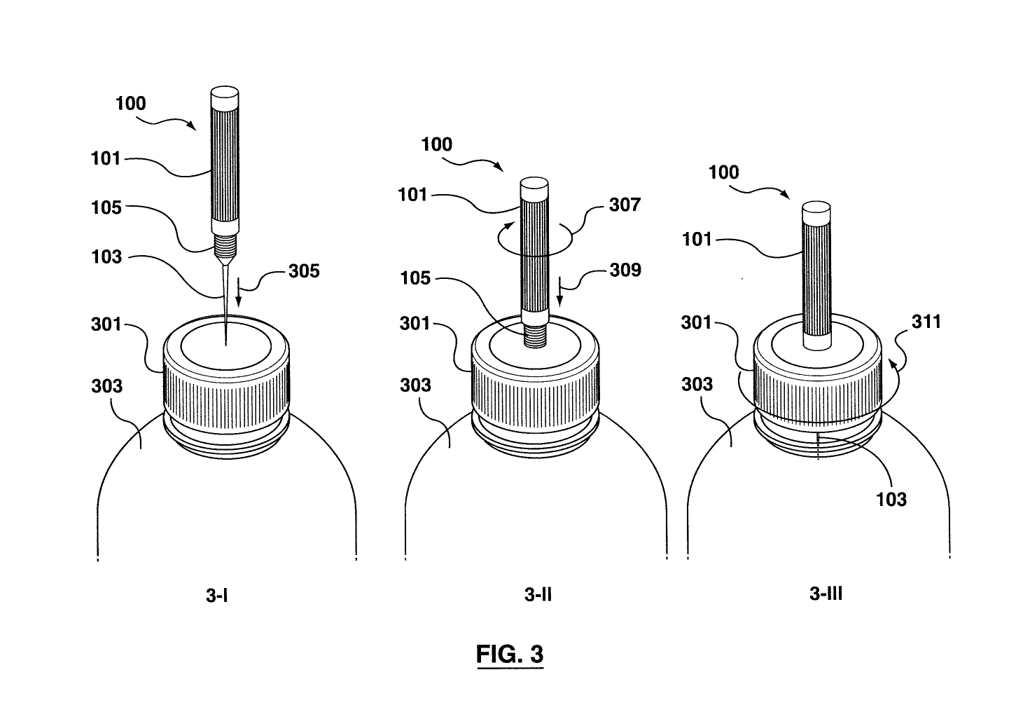

Use of device 100 is now described with reference to FIGS. 3 to 10.

Attention is hence next directed to FIG. 3, which depicts three views 3-I, 3-II, 3-III of a sequence for using device 100 to puncture a top of a threaded bottle cap 301 which can initially be removabley attached to a complementary threaded opening of a bottle 303. In other implementations, threaded bottle cap 301 need not be initially attached to bottle 303 and device 100 can be used to puncture threaded bottle cap 301 when threaded bottle cap 301 is removed from bottle 303. However, when threaded bottle cap 301 is initially attached to bottle 303, bottle 303 can be used to stabilize threaded bottle cap 301 which can make puncturing of threaded bottle cap 301 by device 100 easier.

Further, it is appreciated that the terms “top” and “bottom”, as used herein, is understood to mean a generally flat portion of threaded bottle cap 301 that covers and/or seals the opening of bottle 303 when attached thereto, and the terms “top” and “bottom” are not meant to respectively mean “up” and “down” with respect to the ground and/or earth. For example, threaded bottle cap 301 can be held horizontally, and/or diagonally and/or flipped 180° relative to FIG. 3, and device 100 can still puncture the top of threaded bottle cap 301.

In any event, in view 3-I, a user (not depicted) can hold device 100 by handle 101, and move puncturing portion 103 towards the top of threaded bottle cap 301, as indicated by arrow 305; the combination of the angle of the tip of puncturing portion 103 and force exerted on the top of threaded bottle cap 301 at the tip by the user causes puncturing portion 103 to puncture the top of threaded bottle cap 301; puncturing portion 103 is then inserted into the resulting hole in the top of threaded bottle cap 301 so that engaging portion 105 abuts the top of threaded bottle cap 301, as depicted in view 3-II. In particular, further force exerted through handle on optional transition portion 106 (not depicted in FIG. 3) can widen the hole formed in the material of the top of threaded bottle cap 301 to assist engaging portion 105 with engaging the material of threaded bottle cap 301.

As described above, in depicted implementations, engaging portion 105 is threaded; hence, device 100 can then be turned, as indicated by arrow 307, so that threads 107 of engaging portion 105 engage the material of the top of threaded bottle cap 301. Then, as device 100 turns, the material of the top of threaded bottle cap 301 deform around threads 107, drawing engaging portion 105 further through the top of threaded bottle cap 301, as indicated by arrow 309, thereby engaging the top of threaded bottle cap 301 and generally creating a seal between the top of threaded bottle cap 301 and engaging portion 105.

In implementations where engaging portion 105 comprises ribs, rather than threads, engaging portion 105 can be caused to engage the top of threaded bottle cap 301 be exerting further force on device 100, until the force further widens the hole initially formed by puncturing portion 103, and the ribs of engaging portion 105 engage the material of the top of threaded bottle cap 301.

In any event, in view 3-III, engaging portion 105 is optionally inserted all the way into the top of threaded bottle cap 301 so that a base of engaging portion 105 engages the top of threaded bottle cap 301. Indeed, it is appreciated that the top of threaded bottle cap 301 has a width, and engaging portion 105 can generally be longer than the width of the top of threaded bottle cap.

In any event, as also depicted in implementations depicted in FIG. 3, as a diameter of engaging portion 105 is less than a diameter of handle 101, engaging portion 105 is inserted into the top of threaded bottle cap 301 until handle 101 abuts the top of threaded bottle cap 301.

Device 100 is now engaging and/or attached to threaded bottle cap 301, which can then be removed and/or unscrewed from bottle 303, as indicated by arrow 311.

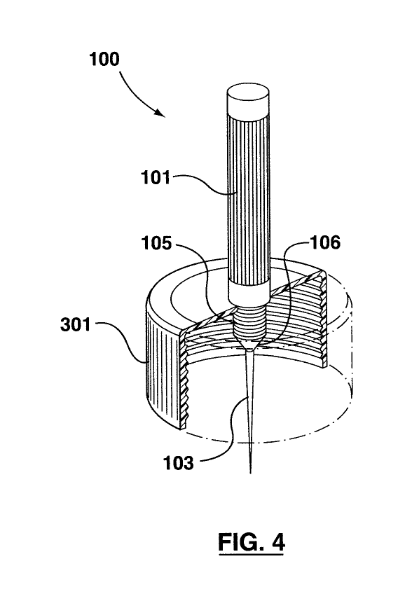

To further illustrate the attachment and/or engagement of device 100 to threaded bottle cap 301, attention is next directed to FIG. 4, which depicts an inside of a lateral cross section of threaded bottle cap 301 with device 100 inserted through the top thereof. It is apparent that a tip of puncturing portion 103 extends beyond a bottom of threaded bottle cap 301, and that engaging portion 105 and transition portion 106 have been inserted through the hole formed by puncturing portion 103, with the material of the top of threaded bottle cap 301 deforming around engaging portion 105.

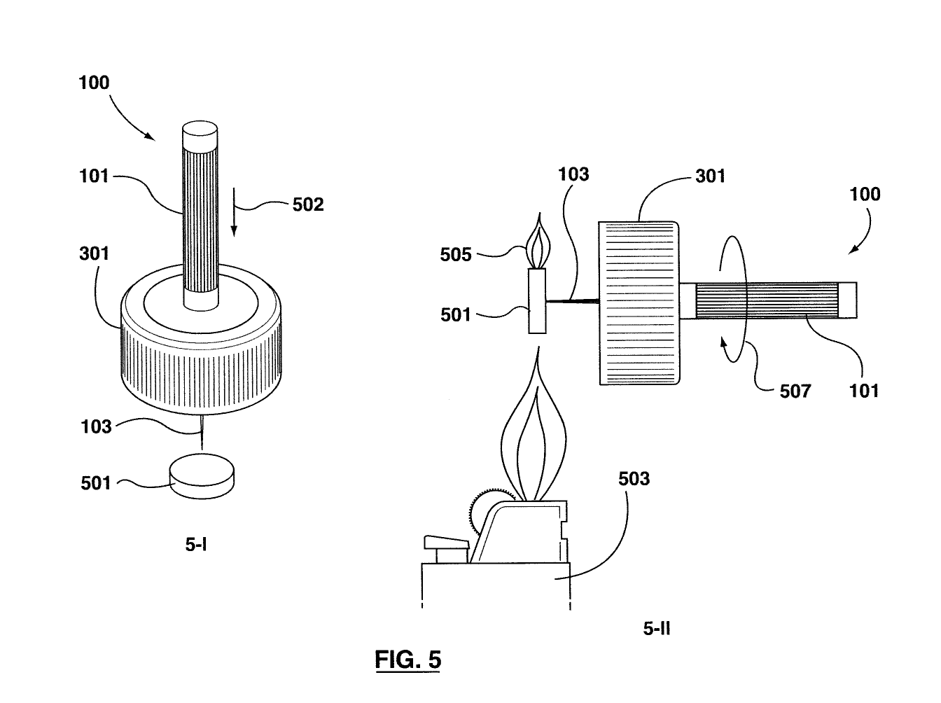

Attention is next directed to FIG. 5, which depicts a two views 5-I, 5-II of a sequence for using device 100 to receive, retain and light a herbal concentrate 501 which can be generally dense and/or sticky, which can include, but is not limited to, concentrated tobacco, concentrated herbs, hash, and the like. While some herbal concentrates are illegal in some jurisdictions, many jurisdictions are becoming increasingly tolerant of such substances and/or are moving towards legalization of such substances.

In any event, in view 5-I, the tip of puncturing portion 103 is used to receive and retain herbal concentrate 501, as indicated by arrow 502, while device 100 is engaging threaded bottle cap 301. Hence, the top of puncturing portion 103 has two functions: puncturing threaded bottle cap 301 and holding and/or receiving and/or retaining herbal concentrate 501. For example, as herbal concentrate 501 is generally of a sufficient consistency and/or sufficient density and/or is oily and/or sticky, so that herbal concentrate 501 generally forms a ball and/or cake of material which can be stuck to the tip of puncturing portion 103.

In view 541, a lighter 503, a candle, a match and the like, can be used to light herbal concentrate 501 on fire, as indicated by flame 505 at herbal concentrate 501. Handle 101 can be used to turn and/or rotate herbal concentrate 501 to assist in lighting herbal concentrate 501, as indicated by arrow 507.

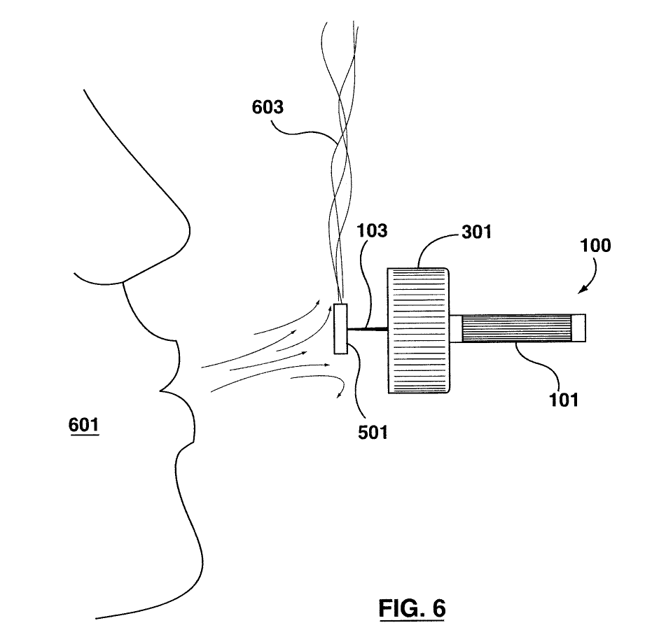

As depicted in FIG. 6, a user 601 can blow on herbal concentrate 501 until flame 505 goes out and/or is extinguished, and herbal concentrate 501 smolders, producing smoke 603.

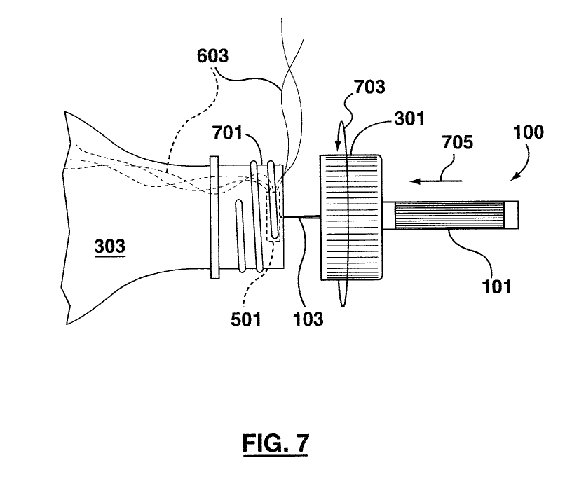

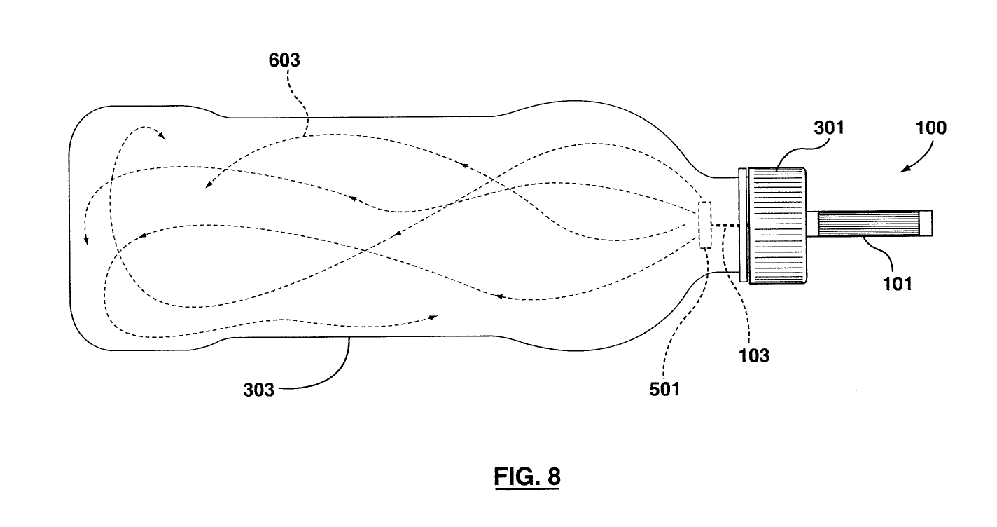

Attention is next directed to FIG. 7, which depicts threaded bottle cap 301 being removabley attached/screwed on to a threaded neck 701 of bottle 303, as indicated by arrows 703, 705, while device 100 is engaging threaded bottle cap 301, and puncturing portion 103 is retaining smoldering herbal concentrate 501. Smoke 603 is then collected inside bottle 303 as threaded bottle cap 301 is removabley attached to bottle 303. This is further illustrated in FIG. 8, which depicts threaded bottle cap 301 removabley attached/screwed on to bottle 303, while device 100 is engaging threaded bottle cap 301, and puncturing portion 103 is retaining smoldering herbal concentrate 501. Herbal concentrate 501 is smoldering inside bottle 303, and smoke 603 is collected inside bottle 303.

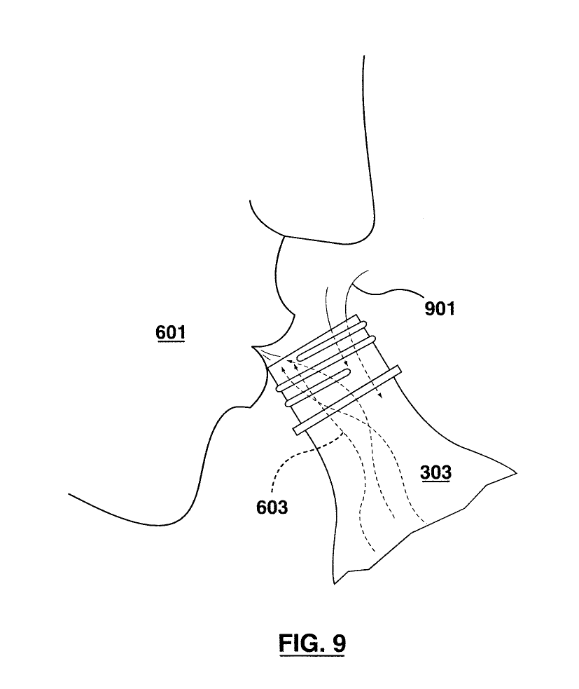

Once smoke 603 collects inside bottle 303, threaded bottle cap 301 can be removed from bottle 303, along with device 100 and, as depicted in FIG. 9, user 601 can place their mouth at the opening of bottle 303 and inhale smoke 603, for example leaving some space at the opening for additional air 901 to flow into bottle 303 as smoke 603 is inhaled; the intake of air 901 assists the smoldering of herbal concentrate 501 due to the introduction of fresh air into bottle 303. Once smoke 603 is inhaled, threaded bottle cap 301, device 100 and smoldering herbal concentrate 501, can be reattached to bottle 303 so that further smoke 603 can collect in bottle 303, and threaded bottle cap 301 again removed so that the further smoke can be inhaled. In other words, the actions represented in FIGS. 7, 8 and 9 are repeated until herbal concentrate 501 is finished and/or stops smoldering. If and/or when herbal concentrate 501 stops smoldering inside bottle 303, herbal concentrate can be relit by removing threaded bottle cap 301 and repeating the actions represented by view 5-II of FIG. 5, and FIG. 6. Further, fumes from burnt fuels for ignition, for example fumes from the match, candle and the like used to light herbal concentrate 501, are dispersed into the atmosphere prior to threaded bottle cap 301 being attached to threaded neck 701, as flame 505 is extinguished external to bottle 303, thereby preventing the fumes from being collected inside bottle 303 so that the fumes are not inhaled. Further, as smoldering of herbal concentrate 501 generally occurs within bottle 303, other than when threaded bottle cap 301 is temporarily removed from bottle 303, the need for using tobacco-like products to aid in the smoldering is obviated (i.e. bottle 303 generally protects smoldering herbal concentrate 501 from the surrounding environment including extinguishing drafts).

Optionally, one or more holes can be punctured in a wall of bottle 303 for inhaling smoke 603, the one or more hole covered when smoke 603 is not being inhaled to allow smoke 603 to collect in bottle 303, for example by fingers and/or a hand of user 601, and/or tape and the like. Device 100 can also be used to puncture one or more holes in a wall of bottle 303.

Hence, device 100 effectively adapts bottle 303 for use as a smoking apparatus. As device 100 can be of dimensions configured for portability, a user need not carry around a special smoking device for smoking herbal concentrate, as such devices can be large and bulky, such as waterpipes; rather a user can conveniently carry device 100 and adapt any bottle with a threaded cap for use as a smoking apparatus. Indeed, with reference to FIGS. 7 and 8, device 100 can be used to adapt bottle 303 as a smoking apparatus such that FIG. 8 depicts a system comprising: a bottle 303 comprising threaded neck 701 defining an opening; a threaded bottle cap 301 complementary to threaded neck 701, threaded bottle cap 301 configured to be removabley attached to threaded neck 701 to seal the opening; and, device 100 comprising: handle 101; puncturing portion 103 extending from handle 101, puncturing portion 103 configured to both: puncture a top of threaded bottle cap 301 such that puncturing portion 103 can be inserted through the top of threaded bottle cap 301; and receive and retain a portion of herbal concentrate 501 thereafter; and, engaging portion 105 configured to engage the top of threaded bottle cap 301 once puncturing portion 103 is inserted there through, such that, when herbal concentrate 501 is one or more of lit and smoldering, once retained by puncturing portion 103, threaded bottle cap 301 can be attached to bottle 303 and smoke 603 from herbal concentrate 501 collected therein, for inhalation when threaded bottle cap 301 is removed from threaded neck 701.

Persons skilled in the art will appreciate that there are yet more alternative implementations and modifications possible. For example, while engaging portion 105 and puncturing portion 103 are depicted as separate portions, in other implementations, puncturing portion 103 can comprise engaging portion 105. For example, puncturing portion 103 can comprise threads and/or ribs at a base adjacent handle 101 and/or along at least a portion of puncturing portion 103. Further, device 100 could further comprises a sealing portion, for example a rubber sleeve, gasket and the like, recessed for example into handle 101 circumferentially around engaging portion 105: in these implementations, threads 107 of engaging portion 105 can draw the top of the threaded bottle cap towards the sealing portion until the sealing portion makes a seal at the top of the threaded bottle cap.

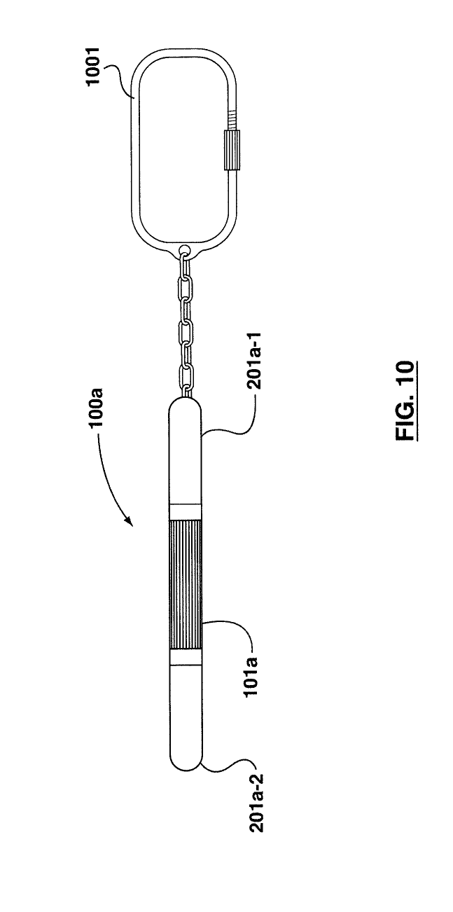

Further, attention is directed to FIGS. 10 to 13, which depict a device 100a similar to device 100, with like elements having like numbers, however with an “a” appended thereto. As depicted in FIG. 10, device 100a comprises a handle 101a, similar to handle 101, and caps 201a-1, 201a-2 at opposite ends of handle 101a, caps 201a-1, 201a-2 each covering a respective puncturing portion as described hereafter. Device 100a further comprises an optional keychain 1001, for example attached to cover 201a-1.

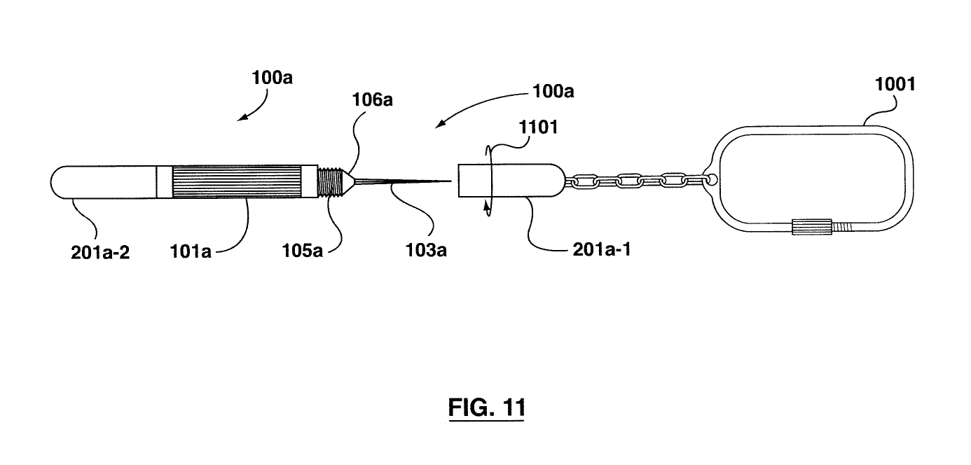

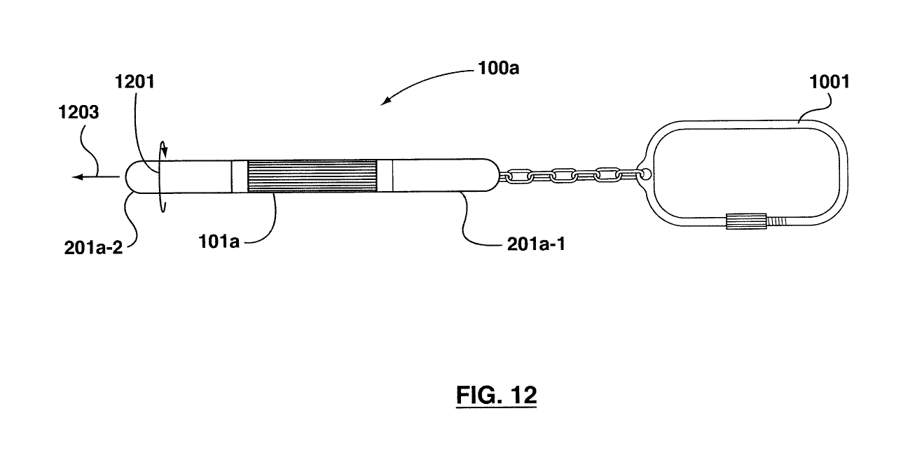

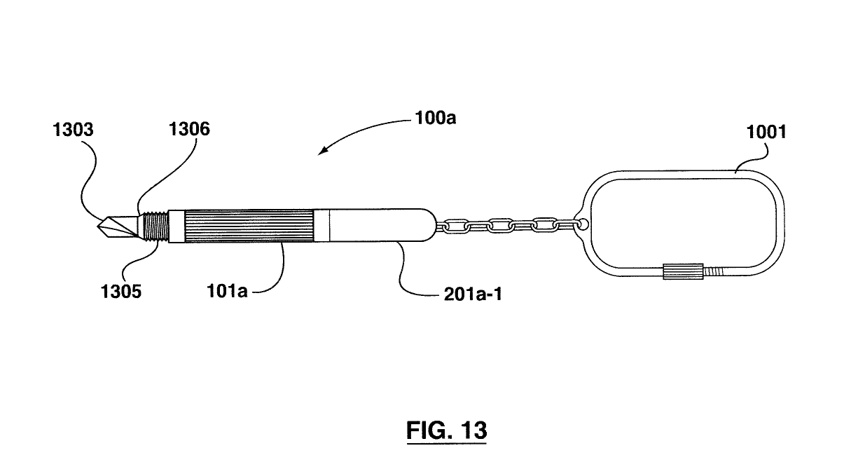

As depicted in FIG. 11, cover 201a-1 can be removed and/or unscrewed (as indicated by arrow 1101) from handle 101a to uncover a puncturing portion 103a, an engaging portion 105a and an optional transition portion 106a, each respectively substantially similar to puncturing portion 103, engaging portion 105 and optional transition portion 106, as described above. However, as depicted in FIG. 12, cover 201a-2 can also be removed and/or unscrewed (as indicated by arrows 1201, 1203) from handle 101a to uncover, as depicted in FIG. 13, a second puncturing portion 1303 extending from handle 101a at an end opposite puncturing portion 103a, second puncturing 1303 portion having one or more of a larger width and a larger diameter than puncturing portion 103a.

Device 100a further comprises a second engaging portion 1305, similar to engaging portion 105, engaging portion 1305 configured to engage a top of a threaded bottle cap once second puncturing portion 1303 is inserted there through. Device 100a further comprises a second transition portion 1306 transitioning a base of second puncturing portion 1303 to a diameter of second engagement portion 1305, and otherwise similar to transition portion 106. Removable cover 201a-2 is hence configured to be retained by second engaging portion 1305, and cover second puncturing portion 1303.

As depicted, second puncturing portion 1303 comprises a drill tip configured to form a larger hole in a threaded bottle cap than first puncturing portion 103a, which comprises one or more of a spike and an awl, similar to implementations of device 100 depicted in FIGS. 1 to 8.

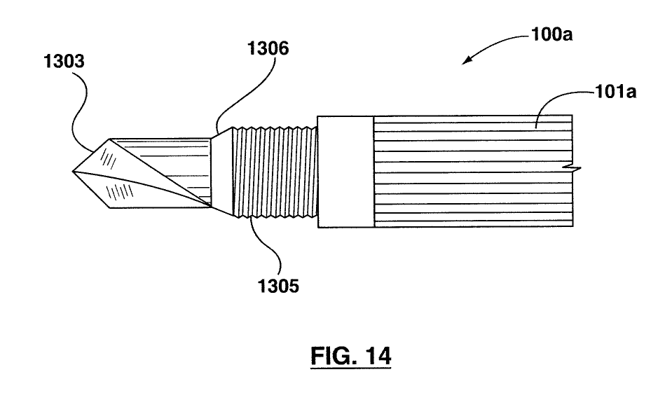

FIG. 14 depicts a portion of device 100a, and in particular an end of device 100a where second puncturing portion 1303 is located, to further illustrate that second puncturing portion 1303 comprises a drill tip. The drill bit can have a diameter of one or of less than about 4 mm, and in a range of 1 mm to 4 mm. However, the drill bit can generally be of larger diameter and/or width than at least a tip of puncturing portion 103a.

In some implementations, second puncturing portion 1303 can be used similar to puncturing portions 103, 103a, such that second puncturing portion 1303 can be used to puncture and/or form a hole in a threaded bottle cap, so that second engaging portion 1305 can engage the threaded bottle cap, similar to engaging portions 105, 105a. However, rather than using a sharp tip to form a hole in the threaded bottle cap, the drill bit of second puncturing portion 1303 comprises a tip with a larger angle than a tip of puncturing portion 103a, and a cutting edge, and hence the tip and cutting edge of second puncturing portion 103a are used to form the hole in a top of a threaded bottle cap. Once engaging portion 1305 engages the threaded bottle cap, the tip of second engaging portion 1303 can be used to receive and retain herbal concentrate, similar to puncturing portions 103, 103a.

However, in other implementations, as second puncturing portion 1303 can have a larger diameter than puncturing portion 103a, the herbal concentrate can tend to go out/stop smoldering due to the larger heat capacity of second puncturing portion 1303. In these implementations, second puncturing portion 1303 can conveniently be used to puncture a top of a threaded bottle cap; then second puncturing portion 1303 can be optionally capped, and device 100 turned around so that narrower puncturing portion 103a can be inserted through the hole formed by second puncturing portion 1303. Engaging portion 103a can then engage the top of the threaded bottle cap and puncturing portion 103a can receive and retain the herbal concentrate for lighting and smoldering. In other words, as second puncturing portion 1303 includes a cutting edge, it can be easier to puncture a top of a threaded bottle cap with second puncturing portion 1303 than with puncturing portion 103a, but puncturing portion 103a can be better suited for retaining smoldering herbal concentrate. Hence, each puncturing portion 103a, 1303 can be used for their specialized functions.

Indeed, in implementations threaded bottle caps can be either plastic or metal, and the drill tip of second puncturing portion 1303 can be better suited to puncture metal due to the cutting edge. Further, some plastic can be harder than other plastics, and the drill tip of second puncturing portion 1303 can be used to at least start a hole in such harder plastics. The hardness of the plastic can also depend on a thickness thereof, so that the same plastic can be more difficult to puncture when thicker. Hence, by providing both puncturing portions 103a, 1303 at device 100a, device 100 can be more versatile than device 100.

In any event, provided herein are various implementations of a convenient and portable device and/or tool, which can be used to adapt a bottle for use as a smoking apparatus. As bottles are prevalent around the world, especially PET bottles with threaded bottle caps, and available from grocery stores, convenience stores and the like, a user need not carry bulky smoking apparatus, such as a shisha, hookah, and the like, to smoke herbal concentrate. Rather devices 100, 100a can be carried to adapt a bottle for use as a smoking apparatus wherever the user may be located. Furthermore, each of device 100 and device 100a can be configured to be pocket sized and a total length of each of device 100 and device 100a can be in a range of about 10 mm to about 200 mm; however other lengths are within the scope of present implementations, for example lengths that enable each device 100 and device 100a to be suitable for carrying in a pocket, including, but not limited to a pocket of an item of clothing.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. A device comprising:
a handle;
a puncturing portion extending from the handle, the puncturing portion configured to both: puncture a top of a threaded bottle cap such that the puncturing portion can be inserted through the top of the threaded bottle cap; and retain a portion of a herbal concentrate thereafter; and,
an engaging portion configured to engage the top of the threaded bottle cap once the puncturing portion is inserted there through.

2. The device of claim 1, wherein the engaging portion is located at a base of the puncturing portion, adjacent the handle.

3. The device of claim 1, wherein a length from a top of the puncturing portion to the handle is greater than or about equal to a cylindrical length of the threaded bottle cap.

4. The device of claim 1, wherein a length from a top of the puncturing portion to the handle is in a range of about 10 mm to about 50 mm.

5. The device of claim 1, wherein an angle of a tip of the puncturing portion is in a range of about 0.1° to about 15°.

6. The device of claim 1, wherein the puncturing portion comprises one or more of a spike and an awl.

7. The device of claim 1, wherein the puncturing portion comprises a drill tip.

8. The device of claim 1, wherein the engaging portion is cylindrical.

9. The device of claim 1, wherein the engaging portion is insertable through the top of the threaded bottle cap once the puncturing portion is inserted there through.

10. The device of claim 1, wherein the engaging portion comprises ribs for engaging the top of the threaded bottle cap when the engaging portion is inserted there through.

11. The device of claim 1, wherein the engaging portion comprises threads for engaging the top of the threaded bottle cap when the engaging portion is inserted there through.

12. The device of claim 1, further comprising a removable cover configured to be retained by the engaging portion and cover the puncturing portion.

13. The device of claim 1, further comprising a key chain.

14. The device of claim 1, further comprising a second puncturing portion extending from the handle at an end opposite the puncturing portion, the second puncturing portion having one or more of a larger width and a larger diameter than the puncturing portion.

15. The device of claim 14, wherein the puncturing portion comprises one or more of a spike and an awl, and the second puncturing portion comprises a drill tip.

16. The device of claim 14, further comprising a second engaging portion configured to engage the top of the threaded bottle cap once the second puncturing portion is inserted there through.

17. The device of claim 16, further comprising a removable cap configured to be retained by the second engaging portion and cover the second puncturing portion.

18. The device of claim 1, wherein the handle comprises an elongated cylinder.

19. The device of claim 1, wherein the handle comprises ribs to assist gripping when one or more of: the puncturing portion is puncturing the threaded bottle cap; and the engaging portion is engaging the top of the threaded bottle cap.

20. A system comprising:
a bottle comprising a threaded neck defining an opening;
a threaded bottle cap complementary to the threaded neck, the threaded bottle cap configured to be removabley attached to the threaded neck; and,
a device comprising:
a handle;
a puncturing portion extending from the handle, the puncturing portion configured to both: puncture a top of the threaded bottle cap such that the puncturing portion can be inserted through the top of the threaded bottle cap; and received and retain a portion of a herbal concentrate thereafter; and,
an engaging portion configured to engage the top of the threaded bottle cap once the puncturing portion is inserted there through, such that, when the herbal concentrate is one or more of lit and smoldering, once retained by the puncturing portion, the threaded bottle cap can be attached to the bottle and smoke from the herbal concentrate collected therein, for inhalation when the threaded bottle cap is removed from the threaded neck.
